(19) United States
(12) Patent Application Publication
(10) Pub. No.: US 2026/0308005 A1
(43) Pub. Date: Oct. 8, 2026

(54) IMPROVED ALPHA ALUMINA COMPOSITIONS

(71) Applicant: CoorsTek, Inc., Golden, CO (US)

(72) Inventors: Steven Landin, Conifer, CO (US); David Henry Hook, Lakewood, CO (US)

(21) Appl. No.: 19/457,615

(22) Filed: Jan. 23, 2026

Related U.S. Application Data
(63) Continuation of application No. PCT/US2024/039511, filed on Jul. 25, 2024.
(60) Provisional application No. 63/531,756, filed on Aug. 9, 2023.

(51) Int. Cl. C01F 7/021

(52) U.S. Cl. CPC C01F 7/021; C01P 2002/52; C01P 2002/60; C01P 2004/02; C01P 2006/10; C01P 2006/21; C01P 2006/40

(57) ABSTRACT

New alpha alumina compositions are disclosed. The new alpha alumina compositions generally include from 20 to 2000 ppm Mg, from 25 to 1000 ppm X, wherein X is selected from the group consisting of Be, Ca, Sr, Ba, Ra, and combinations thereof, from 5 to 200 ppm Si, from 5 to 100 ppm Na, and up to 1000 ppm Fe, the balance being alpha alumina and unavoidable impurities. The new alpha alumina compositions may be sintered to produce polycrystalline alpha alumina products. The polycrystalline alpha alumina products may realize an improved combination of properties, such as an improved combination of two or more of density, modulus of rupture (MOR), loss tangent, and corrosion resistance, among others.

### CROSS-REFERENCE TO RELATED APPLICATION

This patent application is a continuation of International Patent Application No. PCT/US2024/039511, entitled “IMPROVED ALPHA ALUMINA COMPOSITIONS,” filed Jul. 25, 2024, which claims priority to U.S. Provisional Patent Application No. 63/531,756, entitled, “ALPHA ALUMINA COMPOSITIONS,” filed Aug. 9, 2023. Each of the above-identified patent applications are hereby incorporated by reference in their entirety.

### BACKGROUND

Alpha alumina particles are particles of alumina (Al₂O₃) having an alpha phase as the major crystalline phase. Alpha alumina particles may be used as a starting material for producing, for example, alpha alumina sintered bodies.

### SUMMARY OF THE DISCLOSURE

Broadly, the present patent application relates to new alpha alumina compositions having magnesium and at least one other alkaline earth metal, and polycrystalline materials made from such compositions. The new alpha alumina compositions generally comprise (or consist essentially of, or consist of) from 20 to 2000 ppm Mg, from 25 to 1000 ppm of X, wherein X is selected from the group consisting of Be, Ca, Sr, Ba, Ra, and combinations thereof, from 5 to 200 ppm Si, from 5 to 150 ppm Na, up to 1000 ppm Fe, and at least 99.6 wt. % alpha alumina. The new alpha alumina compositions may be sintered to produce polycrystalline alpha alumina products. The polycrystalline alpha alumina products may realize an improved combination of properties, such as an improved combination of two or more of density, modulus of rupture (MOR), loss tangent, and corrosion resistance, among others.

### i. Composition

As noted above, the new alpha alumina compositions generally comprise (or consist essentially of, or consist of) from 20 to 2000 ppm Mg, from 25 to 1000 ppm of X, wherein X is selected from the group consisting of Be, Ca, Sr, Ba, Ra, and combinations thereof, from 5 to 200 ppm Si, from 5 to 150 ppm Na, up to 1000 ppm Fe, and at least 99.6 wt. % alpha alumina. Unless otherwise indicated, as used herein “ppm” means parts-per-million by weight.

Magnesium is generally included in the alpha alumina compositions and in the range of from 25 ppm to 2000 ppm. The magnesium may be introduced to a base alpha alumina composition by any suitable method, such as by doping an alpha alumina feedstock. In one embodiment, magnesium is added to the base alpha alumina feedstock using magnesium nitrate hexahydrate or similar.

In one embodiment, an alpha alumina composition includes not greater than 1900 ppm Mg. In another embodiment, an alpha alumina composition includes not greater than 1800 ppm Mg. In yet another embodiment, an alpha alumina composition includes not greater than 1700 ppm Mg. In another embodiment, an alpha alumina composition includes not greater than 1600 ppm Mg. In yet another embodiment, an alpha alumina composition includes not greater than 1500 ppm Mg. In another embodiment, an alpha alumina composition includes not greater than 1400 ppm Mg. In yet another embodiment, an alpha alumina composition includes not greater than 1300 ppm Mg. In another embodiment, an alpha alumina composition includes not greater than 1200 ppm Mg. In yet another embodiment, an alpha alumina composition includes not greater than 1100 ppm Mg. In another embodiment, an alpha alumina composition includes not greater than 1000 ppm Mg.

In one embodiment, an alpha alumina composition includes at least 30 ppm Mg. In another embodiment, an alpha alumina composition includes at least 40 ppm Mg. In yet another embodiment, an alpha alumina composition includes at least 50 ppm Mg. In another embodiment, an alpha alumina composition includes at least 60 ppm Mg. In yet another embodiment, an alpha alumina composition includes at least 70 ppm Mg. In another embodiment, an alpha alumina composition includes at least 80 ppm Mg. In yet another embodiment, an alpha alumina composition includes at least 90 ppm Mg. In another embodiment, an alpha alumina composition includes at least 100 ppm Mg. In yet another embodiment, an alpha alumina composition includes at least 120 ppm Mg. In another embodiment, an alpha alumina composition includes at least 140 ppm Mg. In yet another embodiment, an alpha alumina composition includes at least 160 ppm Mg. In another embodiment, an alpha alumina composition includes at least 180 ppm Mg. In yet another embodiment, an alpha alumina composition includes at least 200 ppm Mg. In another embodiment, an alpha alumina composition includes at least 250 ppm Mg. In yet another embodiment, an alpha alumina composition includes at least 300 ppm Mg. In another embodiment, an alpha alumina composition includes at least 350 ppm Mg. In yet another embodiment, an alpha alumina composition includes at least 400 ppm Mg.

As noted above, the new alpha alumina compositions generally include from 25 ppm to 1000 ppm of X, wherein X is selected from the group consisting of Be, Ca, Sr, Ba, Ra, and combinations thereof. In one embodiment, X is selected from the group consisting of Ca, Sr, Ba and combinations thereof. In another embodiment, X is selected from the group consisting of Ca, Sr, and combinations thereof. In yet another embodiment, X is Ca. In another embodiment, X is Sr. As used herein, the language “and combinations thereof” should be understood to mean that one or more of the prior listed elements/items may be used, optionally in combination with one or more of the other listed elements/items. For instance, the language “selected from the group consisting of Be, Ca, Sr, Ba, Ra, and combinations thereof” should be understood as allowing for one or more of Be, Ca, Sr, Ba and/or Ra to be used, and includes uses of a single element (e.g., Ba alone; Ca alone) or multiple elements (e.g., Ba and Ca; Ba, Ca and Ra; Ca and Sr; Sr and Ra, etc.).

Like magnesium, the beryllium (Be), calcium (Ca), strontium (Sr), barium (Ba), and radium (Ra) may be introduced to a base alpha alumina composition by any suitable method, such as by doping an alpha alumina feedstock. In one embodiment, X is at least calcium, and calcium is added to the base alpha alumina feedstock using calcium tetrahydrate.

In one embodiment, an alpha alumina composition includes not greater than 900 ppm X. In another embodiment, an alpha alumina composition includes not greater than 800 ppm X. In yet another embodiment, an alpha alumina composition includes not greater than 700 ppm X. In another embodiment, an alpha alumina composition includes not greater than 600 ppm X. In yet another embodiment, an alpha alumina composition includes not greater than 500 ppm X.

In one embodiment, an alpha alumina composition includes at least 30 ppm X. In another embodiment, an alpha alumina composition includes at least 40 ppm X. In yet another embodiment, an alpha alumina composition includes at least 50 ppm X. In another embodiment, an alpha alumina composition includes at least 60 ppm X. In yet another embodiment, an alpha alumina composition includes at least 70 ppm X. In another embodiment, an alpha alumina composition includes at least 80 ppm X. In yet another embodiment, an alpha alumina composition includes at least 90 ppm X. In another embodiment, an alpha alumina composition includes at least 100 ppm X. In yet another embodiment, an alpha alumina composition includes at least 120 ppm X. In another embodiment, an alpha alumina composition includes at least 40 ppm X. In yet another embodiment, an alpha alumina composition includes at least 140 ppm X. In another embodiment, an alpha alumina composition includes at least 160 ppm X. In yet another embodiment, an alpha alumina composition includes at least 180 ppm X. In another embodiment, an alpha alumina composition includes at least 200 ppm X.

As noted above, the new alpha alumina compositions generally include from 5 to 200 ppm Si as an impurity. In one embodiment, an alpha alumina composition includes not greater than 180 ppm Si. In another embodiment, an alpha alumina composition includes not greater than 160 ppm Si. In yet another embodiment, an alpha alumina composition includes not greater than 140 ppm Si. In another embodiment, an alpha alumina composition includes not greater than 120 ppm Si. In yet another embodiment, an alpha alumina composition includes not greater than 100 ppm Si.

In one embodiment, an alpha alumina composition includes at least 10 ppm Si. In another embodiment, an alpha alumina composition includes at least 15 ppm Si. In yet another embodiment, an alpha alumina composition includes at least 20 ppm Si. In another embodiment, an alpha alumina composition includes at least 25 ppm Si. In yet another embodiment, an alpha alumina composition includes at least 30 ppm Si. In another embodiment, an alpha alumina composition includes at least 35 ppm Si. In yet another embodiment, an alpha alumina composition includes at least 40 ppm Si. In another embodiment, an alpha alumina composition includes at least 45 ppm Si. In yet another embodiment, an alpha alumina composition includes at least 50 ppm Si.

As noted above, the new alpha alumina compositions generally include from 5 to 150 ppm Na as an impurity. In one embodiment, an alpha alumina composition includes not greater than 140 ppm Na. In another embodiment, an alpha alumina composition includes not greater than 130 ppm Na. In yet another embodiment, an alpha alumina composition includes not greater than 120 ppm Na. In another embodiment, an alpha alumina composition includes not greater than 110 ppm Na. In yet another embodiment, an alpha alumina composition includes not greater than 100 ppm Na.

In one embodiment, an alpha alumina composition includes at least 10 ppm Na. In another embodiment, an alpha alumina composition includes at least 15 ppm Na. In yet another embodiment, an alpha alumina composition includes at least 20 ppm Na. In another embodiment, an alpha alumina composition includes at least 25 ppm Na. In yet another embodiment, an alpha alumina composition includes at least 30 ppm Na. In another embodiment, an alpha alumina composition includes at least 35 ppm Na. In yet another embodiment, an alpha alumina composition includes at least 40 ppm Na. In another embodiment, an alpha alumina composition includes at least 45 ppm Na. In yet another embodiment, an alpha alumina composition includes at least 50 ppm Na.

As noted above, the new alpha alumina compositions may include up to 1000 ppm Fe as an impurity. In one embodiment, an alpha alumina composition includes not greater than 900 ppm Fe. In another embodiment, an alpha alumina composition includes not greater than 800 ppm Fe. In yet another embodiment, an alpha alumina composition includes not greater than 700 ppm Fe. In another embodiment, an alpha alumina composition includes not greater than 600 ppm Fe. In yet another embodiment, an alpha alumina composition includes not greater than 500 ppm Fe. In another embodiment, an alpha alumina composition includes not greater than 400 ppm Fe. In yet another embodiment, an alpha alumina composition includes not greater than 300 ppm Fe. In another embodiment, an alpha alumina composition includes not greater than 200 ppm Fe.

As noted above, the new alpha alumina compositions generally include at least 99.6 wt. % alpha alumina. In one embodiment, an alpha alumina composition includes at least 99.65 wt. % alpha alumina. In another embodiment, an alpha alumina composition includes at least 99.7 wt. % alpha alumina. In yet another embodiment, an alpha alumina composition includes at least at least 99.75 wt. % alpha alumina. In another embodiment, an alpha alumina composition includes at least 99.8 wt. % alpha alumina. In yet another embodiment, an alpha alumina composition includes at least 99.82 wt. % alpha alumina. In another embodiment, an alpha alumina composition includes at least 99.84 wt. % alpha alumina. In yet another embodiment, an alpha alumina composition includes at least 99.86 wt. % alpha alumina. In another embodiment, an alpha alumina composition includes at least 99.88 wt. % alpha alumina.

In one embodiment, a new alpha alumina composition consists essentially of (or consist of) any of the above recited amounts of magnesium, X (i.e., beryllium, calcium, strontium, barium, radium, and combinations thereof), silicon, sodium, and iron, the balance being alpha alumina and unavoidable impurities. As used herein, “unavoidable impurities” means impurities of the alpha alumina other than silicon, sodium, and iron. Magnesium and X (Be, Ca, Sr, Ba, Ra, and combinations thereof) also are not included in the definition of unavoidable impurities.

In one embodiment, a new alpha alumina composition is in an inorganic form. The inorganic form may include any of the above recited amounts of magnesium, X (Be, Ca, Sr, Ba, Ra, and combinations thereof), silicon, sodium, iron, and the alpha alumina.

In one embodiment, a new alpha alumina composition is in the form of a final powder (e.g., a powder suited for producing commercially viable sintered products). In one embodiment, a final powder includes the above recited amounts of magnesium, X (i.e., beryllium, calcium, strontium, barium, radium, and combinations thereof), silicon, sodium, iron, and the alpha alumina, along with optional powder additives. The powder additives may be, for instance, one or more dispersants, one or more binders, one or more plasticizers, and one or more sintering aids, among others.

In one embodiment, a sintered product is made from a new alpha alumina composition (e.g., from a final powder comprising the new alpha alumina). The sintered product may be, for instance, a bulk polycrystalline alpha alumina product having the above recited amounts of magnesium, X (i.e., beryllium, calcium, strontium, barium, radium, and combinations thereof), silicon, sodium, iron, and the alpha alumina. The polycrystalline alpha alumina product may include any of the above recited amounts of magnesium, X (i.e., beryllium, calcium, strontium, barium, radium, and combinations thereof), silicon, sodium, iron, and the alpha alumina.

### ii. Microstructure

As noted above, the new alpha alumina compositions may be sintered to produce a polycrystalline alpha alumina product. Such polycrystalline alpha alumina products may realize a fine, uniform grain structure.

In one embodiment, a polycrystalline alpha alumina product realizes an average grain size of not greater than 30 micrometers. In another embodiment, a polycrystalline alpha alumina product realizes an average grain size of not greater than 28 micrometers. In yet another embodiment, a polycrystalline alpha alumina product realizes an average grain size of not greater than 26 micrometers. In another embodiment, a polycrystalline alpha alumina product realizes an average grain size of not greater than 24 micrometers. In yet another embodiment, a polycrystalline alpha alumina product realizes an average grain size of not greater than 22 micrometers. In another embodiment, a polycrystalline alpha alumina product realizes an average grain size of not greater than 20 micrometers. In yet another embodiment, a polycrystalline alpha alumina product realizes an average grain size of not greater than 18 micrometers. In another embodiment, a polycrystalline alpha alumina product realizes an average grain size of not greater than 16 micrometers. In yet another embodiment, a polycrystalline alpha alumina product realizes an average grain size of not greater than 14 micrometers. In another embodiment, a polycrystalline alpha alumina product realizes an average grain size of not greater than 12 micrometers. In yet another embodiment, a polycrystalline alpha alumina product realizes an average grain size of not greater than 10 micrometers. In another embodiment, a polycrystalline alpha alumina product realizes an average grain size of not greater than 8 micrometers. In yet another embodiment, a polycrystalline alpha alumina product realizes an average grain size of not greater than 6 micrometers. In another embodiment, a polycrystalline alpha alumina product realizes an average grain size of not greater than 5 micrometers. In yet another embodiment, a polycrystalline alpha alumina product realizes an average grain size of not greater than 4 micrometers. In another embodiment, a polycrystalline alpha alumina product realizes an average grain size of not greater than 3 micrometers. In yet another embodiment, a polycrystalline alpha alumina product realizes an average grain size of not greater than 2 micrometers. In one embodiment, a polycrystalline alpha alumina product realizes an average grain size of at least 0.5 micrometers.

In one embodiment, a polycrystalline alpha alumina product realizes a maximum grain size of not greater than 80 micrometers. In another embodiment, a polycrystalline alpha alumina product realizes a maximum grain size of not greater than 70 micrometers. In yet another embodiment, a polycrystalline alpha alumina product realizes a maximum grain size of not greater than 60 micrometers. In another embodiment, a polycrystalline alpha alumina product realizes a maximum grain size of not greater than 50 micrometers. In yet another embodiment, a polycrystalline alpha alumina product realizes a maximum grain size of not greater than 45 micrometers. In another embodiment, a polycrystalline alpha alumina product realizes a maximum grain size of not greater than 40 micrometers. In yet another embodiment, a polycrystalline alpha alumina product realizes a maximum grain size of not greater than 35 micrometers. In another embodiment, a polycrystalline alpha alumina product realizes a maximum grain size of not greater than 30 micrometers. In yet another embodiment, a polycrystalline alpha alumina product realizes a maximum grain size of not greater than 28 micrometers. In another embodiment, a polycrystalline alpha alumina product realizes a maximum grain size of not greater than 26 micrometers. In yet another embodiment, a polycrystalline alpha alumina product realizes a maximum grain size of not greater than 24 micrometers. In another embodiment, a polycrystalline alpha alumina product realizes a maximum grain size of not greater than 22 micrometers. In yet another embodiment, a polycrystalline alpha alumina product realizes a maximum grain size of not greater than 20 micrometers. In another embodiment, a polycrystalline alpha alumina product realizes a maximum grain size of not greater than 18 micrometers. In yet another embodiment, a polycrystalline alpha alumina product realizes a maximum grain size of not greater than 16 micrometers. In another embodiment, a polycrystalline alpha alumina product realizes a maximum grain size of not greater than 14 micrometers. In yet another embodiment, a polycrystalline alpha alumina product realizes a maximum grain size of not greater than 12 micrometers. In another embodiment, a polycrystalline alpha alumina product realizes a maximum grain size of not greater than 11 micrometers. In yet another embodiment, a polycrystalline alpha alumina product realizes a maximum grain size of not greater than 10 micrometers. In another embodiment, a polycrystalline alpha alumina product realizes a maximum grain size of not greater than 9 micrometers. In yet another embodiment, a polycrystalline alpha alumina product realizes a maximum grain size of not greater than 8 micrometers.

### iii. Methods of Manufacture

The new alpha alumina compositions may be produced in a variety of manners, such as by doping a base alpha alumina powder. In one embodiment, a high purity alpha alumina powder is added to reverse osmosis water to create a suspension. Magnesium (Mg) and at least one of beryllium (Be), calcium (Ca), strontium (Sr), barium (Ba), and radium (Ra) may be also added to achieve any of the compositions described in Section i, above. Optional dispersants may also be added. The suspension may be milled to create a milled product. Optional binders and/or plasticizer may be added to the milled product. The milled product may then be spray dried to create a final powder.

As it relates to sintering, and referring now to FIG. 1, in one embodiment, a method (10) comprises producing a green body (100) from a new alpha alumina composition (e.g., from a final powder comprising an alpha alumina composition) and then sintering the green body (200) at a sintering temperature, thereby forming a polycrystalline alpha alumina product. The green body generally comprises the amounts of magnesium, X (i.e., beryllium, calcium, strontium, barium, radium, and combinations thereof), silicon, sodium, iron, and alpha alumina described in Section i, above. The sintering temperature may be, for instance, one or more temperatures within the range of from 1200° C. to 1800° C.

As it relates to the sintering the green body step (200), the sintering may be conducted in any suitable fashion. In one embodiment, the sintering comprises pressureless (ambient pressure) sintering. In another embodiment, the sintering comprises applying pressure during sintering (e.g., hot press sintering; hot isostatic press sintering). The sintering atmosphere may be any suitable gaseous environment. In one embodiment, the sintering comprises sintering in air. In another embodiment, the sintering comprises sintering in a non-oxygen atmosphere (e.g., a hydrogen atmosphere). In another embodiment, the sintering comprises sintering in an inert atmosphere (e.g., an argon atmosphere).

As noted above, the sintering temperature may be, for instance, one or more temperatures within the range of from 1200° C. to 1800° C. In one embodiment, the sintering temperature is not greater than 1750° C. In another embodiment, the sintering temperature is not greater than 1700° C. In yet another embodiment, the sintering temperature is not greater than 1680° C. In another embodiment, the sintering temperature is not greater than 1660° C. In yet another embodiment, the sintering temperature is not greater than 1640° C. In another embodiment, the sintering temperature is not greater than 1620° C. In yet another embodiment, the sintering temperature is not greater than 1600° C.

### iv. Properties

As noted above, polycrystalline alpha alumina products made from the new alpha alumina compositions may realize an improved combination of properties, such as an improved combination of two or more of density, modulus of rupture (MOR), loss tangent, and corrosion resistance, among others.

As it relates to density, in one embodiment, a polycrystalline alpha alumina product realizes a density of at least 99.1% of its theoretical density, wherein the theoretical density is 3.983 g/cm³. In yet another embodiment, a polycrystalline alpha alumina product realizes a density of at least 99.2% of its theoretical density. In another embodiment, a polycrystalline alpha alumina product realizes a density of at least 99.3% of its theoretical density. In yet another embodiment, a polycrystalline alpha alumina product realizes a density of at least 99.4% of its theoretical density. In another embodiment, a polycrystalline alpha alumina product realizes a density of at least 99.5% of its theoretical density. In yet another embodiment, a polycrystalline alpha alumina product realizes a density of at least 99.6% of its theoretical density. In another embodiment, a polycrystalline alpha alumina product realizes a density of at least 99.7% of its theoretical density. In yet another embodiment, a polycrystalline alpha alumina product realizes a density of at least 99.8% of its theoretical density. In another embodiment, a polycrystalline alpha alumina product realizes a density of at least 99.9% of its theoretical density.

As it relates to modulus of rupture, in one embodiment, a polycrystalline alpha alumina product realizes an MOR (4-pt) strength of at least 400 MPa. In another embodiment, a polycrystalline alpha alumina product realizes an MOR (4-pt) strength of at least 410 MPa. In yet another embodiment, a polycrystalline alpha alumina product realizes an MOR (4-pt) strength of at least 420 MPa. In another embodiment, a polycrystalline alpha alumina product realizes an MOR (4-pt) strength of at least 430 MPa. In yet another embodiment, a polycrystalline alpha alumina product realizes an MOR (4-pt) strength of at least 440 MPa. In another embodiment, a polycrystalline alpha alumina product realizes an MOR (4-pt) strength of at least 450 MPa. In yet another embodiment, a polycrystalline alpha alumina product realizes an MOR (4-pt) strength of at least 460 MPa. In another embodiment, a polycrystalline alpha alumina product realizes an MOR (4-pt) strength of at least 470 MPa. In yet another embodiment, a polycrystalline alpha alumina product realizes an MOR (4-pt) strength of at least 480 MPa. In another embodiment, a polycrystalline alpha alumina product realizes an MOR (4-pt) strength of at least 490 MPa. In yet another embodiment, a polycrystalline alpha alumina product realizes an MOR (4-pt) strength of at least 500 MPa. In another embodiment, a polycrystalline alpha alumina product realizes an MOR (4-pt) strength of at least 510 MPa.

As it relates to loss tangent, in one embodiment, a polycrystalline alpha alumina product realizes a loss tangent (4 GHZ) of not greater than 5.0×10⁻⁴. In another embodiment, a polycrystalline alpha alumina product realizes a loss tangent (4 GHz) of not greater than 4.0×10⁻⁴. In yet another embodiment, a polycrystalline alpha alumina product realizes a loss tangent (4 GHz) of not greater than 3.0×10⁻⁴. In another embodiment, a polycrystalline alpha alumina product realizes a loss tangent (4 GHZ) of not greater than 2.0×10⁻⁴. In yet another embodiment, a polycrystalline alpha alumina product realizes a loss tangent (4 GHZ) of not greater than 1.0×10⁻⁴. In another embodiment, a polycrystalline alpha alumina product realizes a loss tangent (4 GHz) of not greater than 9.0×10⁻⁵. In yet another embodiment, a polycrystalline alpha alumina product realizes a loss tangent (4 GHz) of not greater than 8.0×10⁻⁵. In another embodiment, a polycrystalline alpha alumina product realizes a loss tangent (4 GHz) of not greater than 7.0×10⁻⁵. In yet another embodiment, a polycrystalline alpha alumina product realizes a loss tangent (4 GHz) of not greater than 6.0×10⁻⁵. In another embodiment, a polycrystalline alpha alumina product realizes a loss tangent (4 GHZ) of not greater than 5.0×10⁻⁵. In yet another embodiment, a polycrystalline alpha alumina product realizes a loss tangent (4 GHz) of not greater than 4.0×10⁻⁵. In another embodiment, a polycrystalline alpha alumina product realizes a loss tangent (4 GHz) of not greater than 3.0×10⁻⁵. In yet another embodiment, a polycrystalline alpha alumina product realizes a loss tangent (4 GHZ) of not greater than 2.0×10⁻⁵.

As it relates to dielectric constant, in one embodiment, a polycrystalline alpha alumina product realizes a dielectric constant (4 GHz) of at least 9.85. In another embodiment, a polycrystalline alpha alumina product realizes a dielectric constant (4 GHZ) of at least 9.90. In yet another embodiment, a polycrystalline alpha alumina product realizes a dielectric constant (4 GHz) of at least 9.92. In another embodiment, a polycrystalline alpha alumina product realizes a dielectric constant (4 GHZ) of at least 9.94. In yet another embodiment, a polycrystalline alpha alumina product realizes a dielectric constant (4 GHz) of at least 9.95. In another embodiment, a polycrystalline alpha alumina product realizes a dielectric constant (4 GHZ) of at least 9.96. In yet another embodiment, a polycrystalline alpha alumina product realizes a dielectric constant (4 GHz) of at least 9.97. In another embodiment, a polycrystalline alpha alumina product realizes a dielectric constant (4 GHz) of at least 9.98. In yet another embodiment, a polycrystalline alpha alumina product realizes a dielectric constant (4 GHZ) of at least 9.99 In another embodiment, a polycrystalline alpha alumina product realizes a dielectric constant (4 GHZ) of at least 10.00. In yet another embodiment, a polycrystalline alpha alumina product realizes a dielectric constant (4 GHz) of at least 10.01.

As it relates to corrosion resistance, in one embodiment, a polycrystalline alpha alumina product realizes a mass loss of not greater than 15 mg/dm² when exposed to a room temperature 30% nitric acid, 10% HF solution for 240 hours. In another embodiment, a polycrystalline alpha alumina product realizes a mass loss of not greater than 14 mg/dm² when exposed to a room temperature 30% nitric acid, 10% HF solution for 240 hours. In yet another embodiment, a polycrystalline alpha alumina product realizes a mass loss of not greater than 13 mg/dm² when exposed to a room temperature 30% nitric acid, 10% HF solution for 240 hours. In another embodiment, a polycrystalline alpha alumina product realizes a mass loss of not greater than 12 mg/dm² when exposed to a room temperature 30% nitric acid, 10% HF solution for 240 hours. In yet another embodiment, a polycrystalline alpha alumina product realizes a mass loss of not greater than 11 mg/dm² when exposed to a room temperature 30% nitric acid, 10% HF solution for 240 hours. In another embodiment, a polycrystalline alpha alumina product realizes a mass loss of not greater than 10 mg/dm² when exposed to a room temperature 30% nitric acid, 10% HF solution for 240 hours. In yet another embodiment, a polycrystalline alpha alumina product realizes a mass loss of not greater than 9 mg/dm² when exposed to a room temperature 30% nitric acid, 10% HF solution for 240 hours. In another embodiment, a polycrystalline alpha alumina product realizes a mass loss of not greater than 8 mg/dm² when exposed to a room temperature 30% nitric acid, 10% HF solution for 240 hours. In yet another embodiment, a polycrystalline alpha alumina product realizes a mass loss of not greater than 7 mg/dm² when exposed to a room temperature 30% nitric acid, 10% HF solution for 240 hours. In another embodiment, a polycrystalline alpha alumina product realizes a mass loss of not greater than 6 mg/dm² when exposed to a room temperature 30% nitric acid, 10% HF solution for 240 hours. In yet another embodiment, a polycrystalline alpha alumina product realizes a mass loss of not greater than 5 mg/dm² when exposed to a room temperature 30% nitric acid, 10% HF solution for 240 hours. In another embodiment, a polycrystalline alpha alumina product realizes a mass loss of not greater than 4 mg/dm² when exposed to a room temperature 30% nitric acid, 10% HF solution for 240 hours. In yet another embodiment, a polycrystalline alpha alumina product realizes a mass loss of not greater than 3 mg/dm² when exposed to a room temperature 30% nitric acid, 10% HF solution for 240 hours. In another embodiment, a polycrystalline alpha alumina product realizes a mass loss of not greater than 2 mg/dm² when exposed to a room temperature 30% nitric acid, 10% HF solution for 240 hours. In yet another embodiment, a polycrystalline alpha alumina product realizes a mass loss of not greater than 1 mg/dm² when exposed to a room temperature 30% nitric acid, 10% HF solution for 240 hours.

### V. Product Form and Applications

The new alpha alumina materials described herein may be in an inorganic form, containing any of the above noted amounts of silicon, sodium, magnesium, X (i.e., beryllium, calcium, strontium, barium, radium, and combinations thereof), iron and alpha alumina, along with any unavoidable impurities.

In one approach, the new alpha alumina materials are in a final powder form, containing any of the above noted amounts of silicon, sodium, magnesium, X (i.e., beryllium, calcium, strontium, barium, radium, and combinations thereof), iron and alpha alumina, along with any unavoidable impurities, plus any optional powder additives (e.g., binders, dispersants, plasticizers, sintering aids).

In another approach, a polycrystalline alpha alumina product comprises the new alpha alumina materials. In one embodiment, a new polycrystalline alpha alumina product is in a bulk (monolithic) form, containing any of the above noted amounts of silicon, sodium, magnesium, X (i.e., beryllium, calcium, strontium, barium, radium, and combinations thereof), iron and alpha alumina, along with any unavoidable impurities.

The new polycrystalline alpha alumina product may take on a variety of product forms and may be used in a variety of industrial applications. In one embodiment, a polycrystalline alpha alumina product is used as a “dielectric substrate,” allowing highly efficient transmission of electromagnetic waves (e.g., RF energy). For instance, the dielectric substrate may be a window or a lid used in a semiconductor processing apparatus. The very low dielectric loss tangent properties of the new polycrystalline alpha alumina products described herein may facilitate precise transmission of electromagnetic waves therethrough, resulting in enhanced process uniformity and control.

In another embodiment, a polycrystalline alpha alumina product is used in in a high power application, such as for a klystron window. In these applications, a very low loss tangent is desired such that dielectric heating can be minimized.

### vi. Material Characterization

The below standards should be used to determine material properties of the polycrystalline alpha alumina products described herein.
Density should be measured in accordance with ASTM C373-18.
Grain size should be measured in accordance with ASTM E112-13 (2021).
Modulus of rupture (MOR) should be measured in accordance with C1161-18, wherein the test bars are fabricated to the “Type B Configuration,” with a bar thickness (A) of 4 mm and a bar width (B) of 3 mm. A minimum of 5 bars are used for the test.
Dielectric constant and loss tangent testing should be conducted by evaluation of the dominant TE01 (transverse electric) Resonant Mode. Such evaluation methods are described, for instance, in the following NIST (National Institute of Standards and Technology) Technical Note:
   Janezic, Michael D., N. Paulter, and J. Blendell. “Dielectric and conductor-loss characterization and measurements on electronic packaging materials,” NIST Technical note 1520 (2001), available online at: https://doi.org/10.6028/NIST.TN.1520

### vii. Miscellaneous

These and other aspects, advantages, and novel features of this new technology are set forth in part in the descriptions and figures herein and will become apparent to those skilled in the art upon examination of the descriptions and figures herein, or may be learned by practicing one or more embodiments of the technology provided for by the present disclosure.

Among those benefits and improvements that have been disclosed, other objects and advantages of this invention will become apparent from the descriptions and figures herein. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references, unless the context clearly dictates otherwise. The meaning of “in” includes “in” and “on,” unless the context clearly dictates otherwise.

While a number of embodiments of the present invention have been described, it is understood that these embodiments are illustrative only, and not restrictive, and that many modifications may become apparent to those of ordinary skill in the art. Further still, unless the context clearly requires otherwise, the various steps may be carried out in any desired order, and any applicable steps may be added and/or eliminated.

### BRIEF DESCRIPTION OF THE DRAWINGS

FIG. 1 illustrates one non-limiting embodiment of a method for producing a new polycrystalline alpha alumina product.

FIGS. 2a-2c illustrate various properties of alpha alumina materials as a function of calcium content with <10 ppm magnesium.

FIGS. 3a-3c illustrate various properties of alpha alumina materials as a function of calcium content with about 200 ppm magnesium.

FIGS. 4a-4c illustrate various properties of alpha alumina materials as a function of magnesium content with about 200 ppm calcium.

FIG. 5a is a micrograph of a bulk material produced from the new alpha alumina materials described herein.

FIG. 5b is a micrograph of a bulk material produced from a conventional 99.5 wt. % alpha alumina.

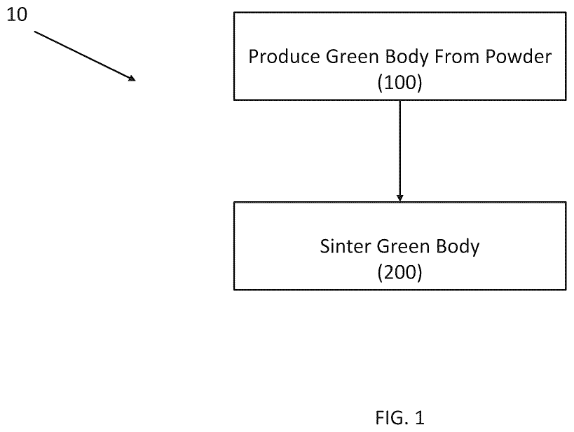

### DETAILED DESCRIPTION

### Example 1—Effect of Magnesium and Calcium on Alpha Alumina

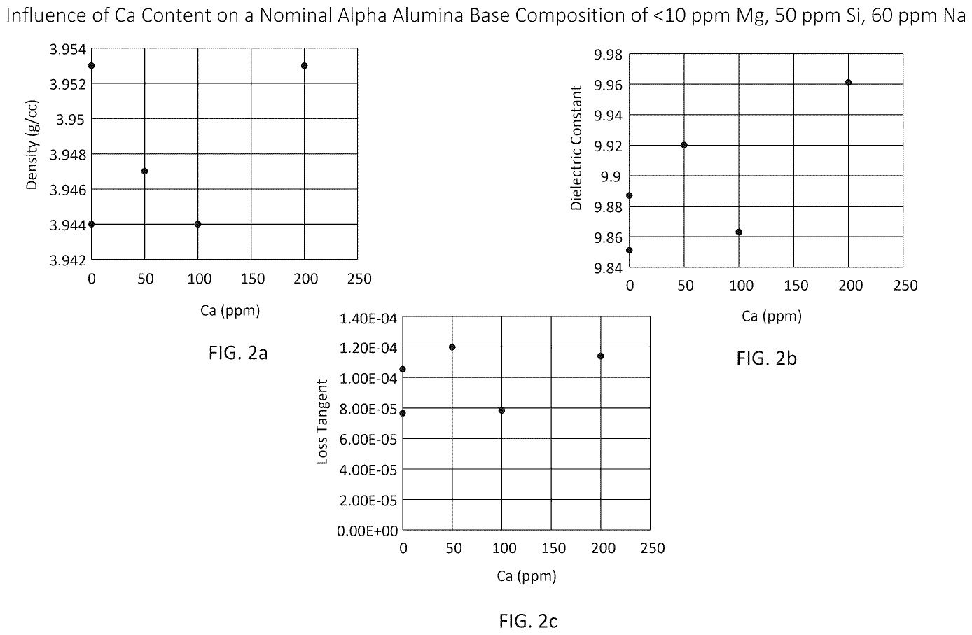

Several alpha alumina powders were prepared having approximately 50 ppm of sodium (Na), 60 ppm of silicon (Si), 90 ppm iron (Fe), and various amounts of magnesium (Mg) and calcium (Ca), as shown in Table 1, below. Several coupons of the various powders were prepared by pressing into a green body. The coupons were about 1 inch (2.54 cm) in diameter and about 0.5 inch (1.27 cm) thick. The coupons were then sintered at a temperature of approximately 1590° C. for about 4 hours in air at ambient pressure, thereby producing a variety of polycrystalline alpha alumina products. Various properties of the sintered products were tested, the results of which are shown in Table 1, below. Corresponding graphs are provided in FIGS. 2a-4c.

TABLE 1
Compositions and properties for Example 1

| | | | | Dielectric | |
|---|---|---|---|---|---|
| Coupon | Magnesium | Calcium | Density | Constant | Loss Tangent |
| No. | (ppm) | (ppm) | (g/cm³) | (4 GHz) | (4 GHz) |
| 1-1 | <10 | 0 | 3.944 | 9.887 | 7.65E−05 |
| 1-2 | <10 | 0 | 3.953 | 9.851 | 1.05E−04 |
| 1-3 | <10 | 50 | 3.947 | 9.92 | 1.20E−04 |
| 1-4 | <10 | 100 | 3.944 | 9.863 | 7.83E−05 |
| 1-5 | <10 | 200 | 3.953 | 9.961 | 1.14E−04 |
| 2-1 | 200 | 0 | 3.966 | 9.984 | 6.77E−04 |
| 2-2 | 200 | 50 | 3.961 | 9.985 | 1.27E−04 |
| 2-3 | 200 | 100 | 3.968 | 9.996 | 9.52E−05 |
| 2-4 | 200 | 200 | 3.97 | 10.002 | 3.69E−05 |
| 2-5 | 200 | 200 | 3.966 | 10.001 | 3.00E−05 |
| 2-6 | 200 | 300 | 3.962 | 10.015 | 4.98E−05 |
| 3-1 | 0 | 200 | 3.953 | 9.961 | 1.14E−04 |
| 3-2 | 100 | 200 | 3.967 | 9.98 | 3.87E−05 |
| 3-3 | 200 | 200 | 3.970 | 10.002 | 3.69E−05 |
| 3-4 | 200 | 200 | 3.966 | 10.001 | 3.00E−05 |
| 3-5 | 400 | 200 | 3.969 | 10.013 | 3.05E−05 |
| 3-6 | 600 | 200 | 3.966 | 10.012 | 3.28E−05 |

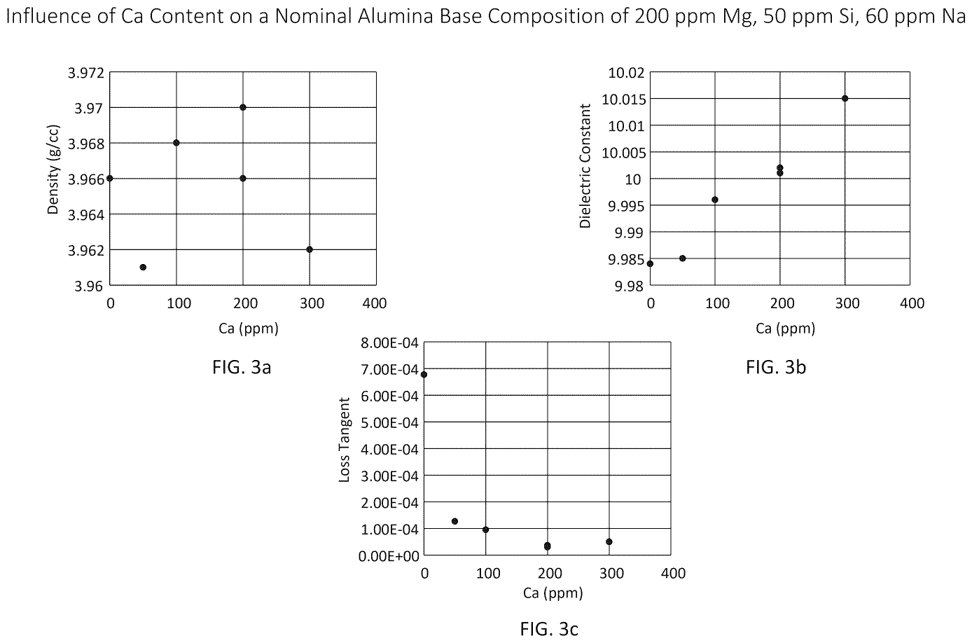

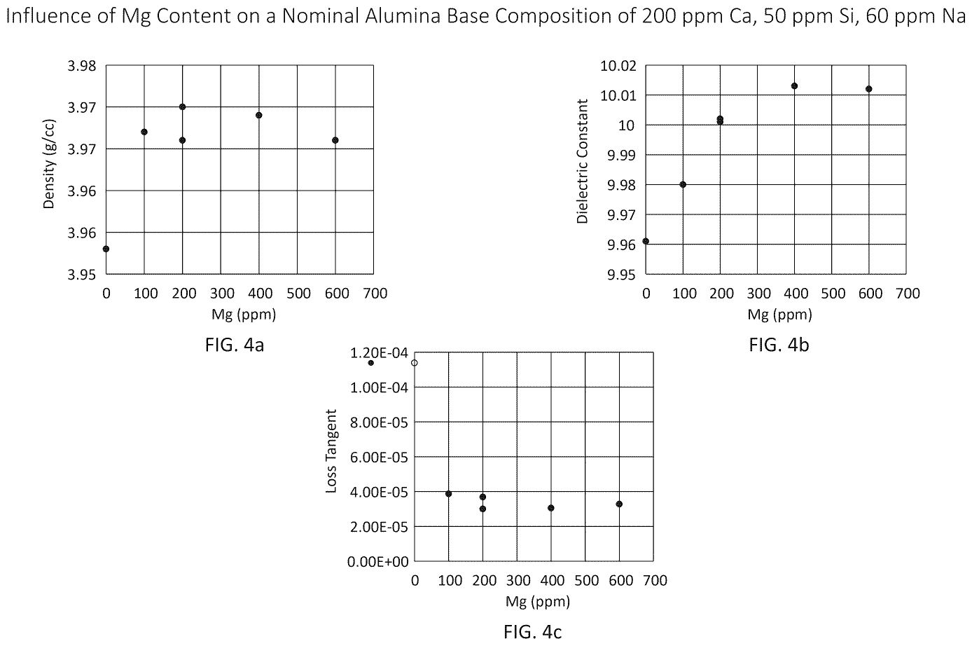

As shown in Table 1 and FIGS. 2a-2c, for the first set of coupons (1-1 through 1-5), the use of from 50-200 ppm calcium alone provides no discernible benefit in relation to density, dielectric constant or loss tangent in relation to the same samples having no calcium. However, as shown in Table 1 and FIGS. 3a-3c, increasing levels of calcium in combination with 200 ppm of magnesium unexpectedly provides increasing benefits to dielectric constant and loss tangent without materially affecting density. As also shown in Table 1 and FIGS. 4a-4c, increasing levels of magnesium with 200 ppm calcium also unexpectedly provides increasing benefits to density and loss tangent.

### Example 2—Effect of 400 ppm Mg and 240 ppm Ca on Alpha Alumina

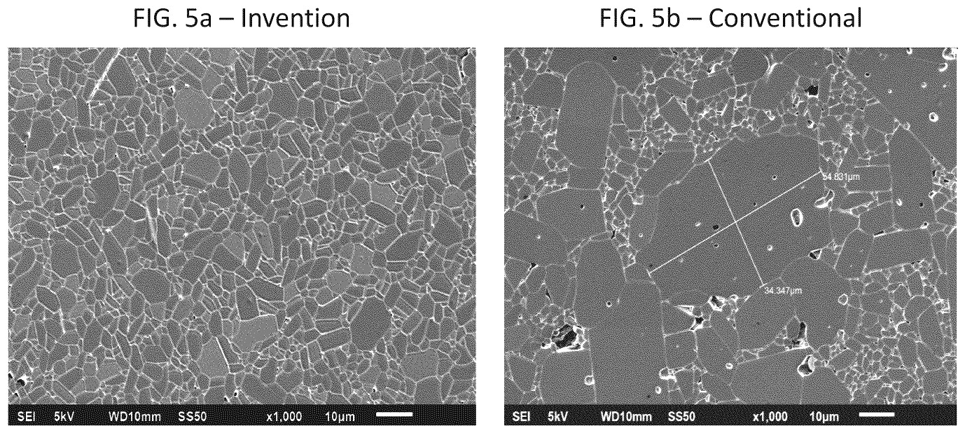

An alpha alumina powder was doped with approximately 400 ppm Mg and 200 ppm of Ca. The resulting alpha alumina powder contained approximately 40 ppm Na, 15 ppm Si, 85 ppm Fe, 240 ppm Ca, and 400 ppm Mg. The alpha alumina powder was then pressed into a large coupon (10.16×10.16×3.175 cm), followed by sintering at a temperature of approximately 1590° C. for about 4 hours in air at ambient pressure, thereby producing a polycrystalline alpha alumina product. Various properties of the sintered product were then tested, the results of which are listed below:
Density: 3.970 g/cm³
Dielectric Constant (4 GHz): 10.0
Loss Tangent (4 GHZ): 4.8E-5
4-Point MOR (ASTM C1161): 511 MPa
Average Grain Size (ASTM E112): 1.94 micrometers
Maximum Grain Size (ASTM E112): 8.4 micrometers.
   As shown, the sintered product realizes exceptional density, loss tangent and modulus of rupture properties. As shown in FIG. 5a and by the data, the grain size is uniform and generally homogenous. By comparison, a conventional 99.5 wt. % alpha alumina material (FIG. 5b) realizes a non-uniform grain structure with significantly larger grains among pockets of smaller grains.

### Example 3—Full Size Semiconductor Component Blanks

A first alpha alumina powder was doped with 400 ppm Mg. After doping, the first alpha alumina powder contained approximately 40 ppm Na, 15 ppm Si, 85 ppm Fe, 40 ppm Ca, and 400 ppm Mg. A second alpha alumina powder was doped with approximately 400 ppm Mg and 200 ppm of Ca. After doping, the second alpha alumina powder contained approximately 40 ppm Na, 15 ppm Si, 85 ppm Fe, 240 ppm Ca, and 400 ppm Mg.

The first alpha alumina powder was pressed into a full-size semiconductor component blank (54.61 cm diameter; 3.175 cm thickness), followed by sintering at a temperature of approximately 1590° C. for about 4 hours in air at ambient pressure, producing Sintered Component A, which was a polycrystalline alpha alumina product. The second alpha alumina powder was processed in the same manner, producing Sintered Component B, which was a polycrystalline alpha alumina product. Various properties of the sintered components were then tested, the results of which are shown below.

| | Sintered | Sintered |
|---|---|---|
| Property | Component A | Component B |
| Density | 3.970 | 3.967 |
| (g/cm3) | | |
| Average Grain Size | 3.15 | 3.50 |
| (ASTM E112) | | |
| micrometers | | |
| Dielectric Constant | 10.0 | 10.0 |
| (4 GHz) | | |
| Loss Tangent | 3.53E−4 | 5.18E−5 |
| (4 GHz) | | |

As shown, despite having nearly identical densities, grain size and dielectric constants, Sintered Component B (having additions of both calcium and magnesium) realized almost an order of magnitude lower loss tangent than Sintered Component A (having magnesium additions only).

### Example 4—Corrosion Resistance Testing

Two sintered coupons (5.08×5.08×0.635 cm) were produced generally as per Example 1, the first coupon being produced from a conventional 99.5% purity alpha alumina powder and the coupon being produced from the second alpha alumina powder of Example 3. The sintered coupons were each exposed to a room temperature 30% nitric acid, 10% HF solution for 240 hours. The conventional (first) coupon realized a mass loss of approximately 64 mg/dm² after 240 hours of testing, while the second coupon produced from the second alpha alumina powder extraordinarily showed negligible mass loss, realizing a mass loss of less than 1 mg/dm² after 240 hours of testing.

### Example 5—Use of Strontium

An alpha alumina powder having approximately 50 ppm sodium (Na), 60 ppm silicon (Si), 90 ppm iron (Fe), 200 ppm magnesium (Mg), and 200 ppm strontium (Sr) was prepared and then pressed into a green body coupon about 1 inch (2.54 cm) in diameter and about 0.5 inch (1.27 cm) thick. The coupon was then sintered at a temperature of approximately 1590° C. for about 4 hours in air at ambient pressure, thereby producing a polycrystalline alpha alumina product. Various properties of the sintered product were then tested, the results of which are shown below.
Density: 3.956 g/cm3
Dielectric Constant (4 GHZ): 9.935
Loss Tangent (4 GHZ): 2.24E-5.

As shown, excellent density and loss tangent properties are realized with the strontium containing materials. Thus, strontium may be used as a substitute in whole or in part for calcium in the new alpha alumina materials described herein. It is anticipated that other alkaline earth metals may also be used as a substitute (in whole or in part) for calcium and without materially affecting density and/or loss tangent properties.

While various embodiments of the present disclosure have been described in detail, it is apparent that modifications and adaptations of those embodiments will occur to those skilled in the art. However, it is to be expressly understood that such modifications and adaptations are within the spirit and scope of the present disclosure.

What is claimed is:

1. An inorganic alpha alumina composition comprising:
from 20 to 2000 ppm Mg;
from 25 to 1000 ppm of X;
wherein X is selected from the group consisting of Be, Ca, Sr, Ba, Ra, and combinations thereof;
from 5 to 200 ppm Si;
from 5 to 150 ppm Na;
up to 1000 ppm (by weight) Fe, and
at least 99.6 wt. % alpha alumina.

2. The inorganic alpha alumina composition of claim 1, comprising from 25 to 160 ppm Si.

3. The inorganic alpha alumina composition of claim 1, comprising from 25 to 100 ppm Na.

4. The inorganic alpha alumina composition of claim 1, comprising from 50 to 1500 ppm Mg.

5. The inorganic alpha alumina composition of claim 1, comprising from 50 to 700 ppm X.

6. The inorganic alpha alumina composition of claim 5, wherein X is selected from the group consisting of Ca, Sr, Ba and combinations thereof.

7. The inorganic alpha alumina composition of claim 1, comprising not greater than 600 ppm Fe.

8. The inorganic alpha alumina composition of claim 1, comprising at least 99.8 wt. % alpha alumina.

9. The inorganic alpha alumina composition of claim 1, consisting of the Mg, X, Si, Na, and Fe, the balance being the alpha alumina and unavoidable impurities.

10. The inorganic alpha alumina composition of claim 1, wherein the inorganic alpha alumina composition is in the form of a powder.

11. A polycrystalline alpha alumina product comprising:
from 20 to 2000 ppm Mg;
from 25 to 1000 ppm of X;
wherein X is selected from the group consisting of Be, Ca, Sr, Ba, Ra, and combinations thereof;
from 5 to 200 ppm Si;
from 5 to 150 ppm Na;
up to 1000 ppm (by weight) Fe; and
at least 99.6 wt. % alpha alumina.

12. The polycrystalline alpha alumina product of claim 11, wherein the product is monolithic.

13. The polycrystalline alpha alumina body of any of claim 12, wherein the product is in the form of a component for a semiconductor processing apparatus.

14. The polycrystalline alpha alumina product of claim 11, wherein the polycrystalline alpha alumina product realizes a density of at least 99.1% of its theoretical density, wherein the theoretical density is 3.983 g/cm³.

15. The polycrystalline alpha alumina product of claim 11, wherein the polycrystalline alpha alumina product realizes a dielectric constant (4 GHZ) of at least 9.85.

16. The polycrystalline alpha alumina product of 11, wherein the polycrystalline alpha alumina product realizes a loss tangent (4 GHZ) not greater than 5.0×10⁻⁴.

17. The polycrystalline alpha alumina product of claim 11, wherein the polycrystalline alpha alumina product realizes an average grain size of not greater than 30 micrometers and a maximum grain size of not greater than 80 micrometers.

18. The polycrystalline alpha alumina product of claim 11, wherein the polycrystalline alpha alumina product realizes an MOR (4-pt) strength of at least 400 MPa.

19. A method comprising:
(a) adding from 25 to 2000 ppm magnesium to an alpha alumina powder;
(b) adding from 25 to 1000 ppm X to the alpha alumina powder;
wherein X is selected from the group consisting of Be, Ca, Sr, Ba, Ra, and combinations thereof; and
(c) optionally adding one or more powder additives to the alpha alumina powder;
wherein, at least partially due to steps (a)-(b) and optional step (c), a doped alpha alumina powder is produced.

20. The method of claim 19, comprising:
producing a green body from the doped alpha alumina powder; and
sintering the green body at a sintering temperature of from 1200-1800° C., thereby forming a sintered component.
